(19) United States
(12) Patent Application Publication
(10) Pub. No.: US 2026/0351017 A1
(43) Pub. Date: Nov. 5, 2026

(54) VEHICLE CONTROL APPARATUS, METHOD, AND COMPUTER-READABLE MEDIUM

(71) Applicant: NEC Corporation, Minto-ku, Tokyo (JP)

(72) Inventors: Takuya SETO, Tokyo (JP); Yuta SHIMIZU, Tokyo (JP); Koyo SHIBATA, Tokyo (JP); Kazuki INAGAKI, Tokyo (JP); Kohei HIJIKATA, Tokyo (JP)

(73) Assignee: NEC Corporation, Minto-ku, Tokyo (JP)

(21) Appl. No.: 19/119,872

(22) PCT Filed: Oct. 26, 2022
(86) PCT No.: PCT/JP2022/039899

§ 371 Date: Apr. 10, 2025

(51) Int. Cl. G06V 20/59; G06V 40/16

(52) U.S. Cl. CPC G06V 20/59; G06V 40/172; G06V 40/178

(57) ABSTRACT

Riding situation acquisition means acquires a riding situation of an occupant riding in a vehicle. Control content acquisition means uses control information to acquire control content corresponding to the acquired riding situation. Control means controls one or more controlled devices in accordance with the acquired control content. Determination means determines whether or not to update the control information on the basis of the control executed by the control means on the one or more controlled devices and an operation result for the one or more controlled devices. In a case where it is determined to execute updating, update means updates the control information on the basis of an operation of the occupant on the one or more controlled devices.

### TECHNICAL FIELD

The present disclosure relates to a vehicle control apparatus, a method, and a computer-readable medium.

### BACKGROUND ART

As a related art, Patent Literature 1 discloses a vehicle control apparatus. The vehicle control apparatus described in Patent Literature 1 learns, as a habit of an occupant, a correspondence relationship between a riding situation of the occupant riding in a vehicle and seat arrangement and a door opening operation executed by the occupant. In Patent Literature 1, the riding situation includes the number of occupants, a combination of occupants, and a riding time. The vehicle control apparatus detects a riding situation when the occupant rides in the vehicle, and in a case where the detected riding situation of the occupant matches the riding situation in the learned habit, automatically executes, as vehicle control, the seat arrangement and the door opening operation learned as the habit.

### CITATION LIST

### Patent Literature

Patent Literature 1: Japanese Unexamined Patent Application Publication No. 2017-202767

### SUMMARY OF INVENTION

### Technical Problem

The vehicle control apparatus described in Patent Literature 1 detects the riding situation, and automatically executes control of a controlled device learned as the habit, that is, the seat arrangement and the door opening operation according to the detected riding situation. However, in Patent Literature 1, even in the same riding situation, the habit of the occupant may change. Even in a case where a habit of an occupant changes from one habit to another habit, the vehicle control apparatus described in Patent Literature 1 automatically executes the door opening operation and the like according to the original habit. In a case where a door that does not need to be opened is opened, an occupant needs to manually close the door.

In view of the above circumstances, an object of the present disclosure is to provide a vehicle control apparatus, a method, and a computer-readable medium capable of changing control content for a controlled device according to a reaction of an occupant to control of the controlled device.

### Solution to Problem

To achieve the above object, the present disclosure provides a vehicle control apparatus as a first aspect. The vehicle control apparatus includes: riding situation acquisition means for acquiring a riding situation of an occupant riding in a vehicle; control content acquisition means for acquiring control content corresponding to the acquired riding situation by using control information in which riding situations and control content of one or more controlled devices are associated with each other; control means for controlling the one or more controlled devices in accordance with the acquired control content; determination means for determining whether or not to update the control information on the basis of the control executed by the control means on the one or more controlled devices and an operation result for the one or more controlled devices; and update means for updating the control information on the basis of an operation of the occupant on the one or more controlled devices in a case where the determination means determines to update the control information.

The present disclosure provides a vehicle control method as a second aspect. The vehicle control method includes: acquiring a riding situation of an occupant riding in a vehicle; acquiring control content corresponding to the acquired riding situation by using control information in which riding situations and control content of one or more controlled devices are associated with each other; controlling the one or more controlled devices in accordance with the acquired control content; determining whether or not to update the control information on the basis of the control on the one or more controlled devices and an operation result for the one or more controlled devices; and updating the control information on the basis of an operation of the occupant on the one or more controlled devices in a case where it is determined to update the control information.

The present disclosure provides a computer-readable medium as a third aspect. The computer-readable medium stores a program for causing a processor to execute processing including: acquiring a riding situation of an occupant riding in a vehicle; acquiring control content corresponding to the acquired riding situation by using control information in which riding situations and control content of one or more controlled devices are associated with each other; controlling the one or more controlled devices in accordance with the acquired control content; determining whether or not to update the control information on the basis of the control on the one or more controlled devices and an operation result for the one or more controlled devices; and updating the control information on the basis of an operation of the occupant on the one or more controlled devices in a case where it is determined to update the control information.

### Advantageous Effects of Invention

A device control apparatus, a method, and a computer-readable medium according to the present disclosure can change control content for a controlled device according to a reaction of an occupant to control of the controlled device.

### BRIEF DESCRIPTION OF DRAWINGS

FIG. 1 is a block diagram illustrating a schematic configuration example of a vehicle control apparatus according to the present disclosure.

FIG. 2 is a block diagram illustrating a vehicle control apparatus according to a first example embodiment of the present disclosure.

FIG. 3 is a diagram illustrating a specific example of a control table.

FIG. 4 is a flowchart illustrating an operation procedure of the vehicle control apparatus.

FIG. 5 is a diagram illustrating a specific example of a control table used in a second example embodiment of the present disclosure.

FIG. 6 is a block diagram illustrating a vehicle control apparatus according to a third example embodiment of the present disclosure.

FIG. 7 is a block diagram illustrating a hardware configuration of the vehicle control apparatus.

### EXAMPLE EMBODIMENT

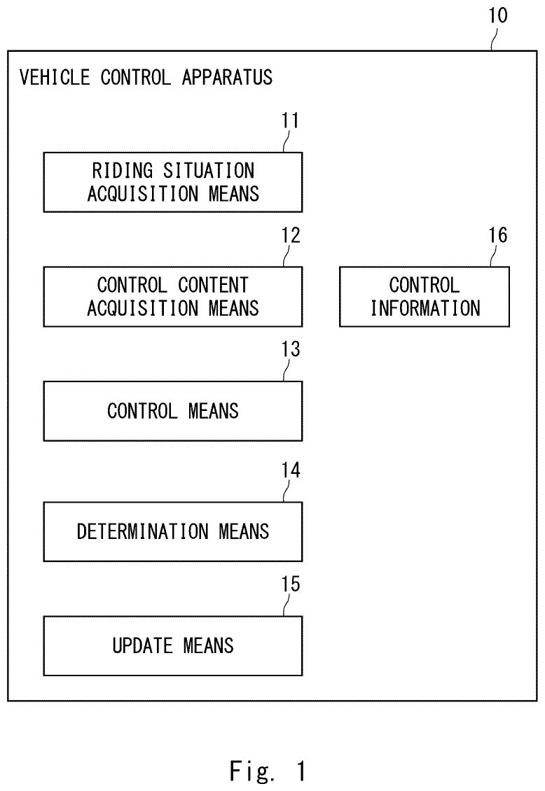

Prior to describing example embodiments of the present disclosure, an outline of the present disclosure will be described. FIG. 1 illustrates a schematic configuration example of a vehicle control apparatus according to the present disclosure. A vehicle control apparatus 10 includes riding situation acquisition means 11, control content acquisition means 12, control means 13, determination means 14, and update means 15.

The riding situation acquisition means 11 acquires a riding situation of an occupant riding in a vehicle. Control information 16 is information in which the riding situation is associated with control content of one or more controlled devices. The control content acquisition means 12 uses the control information 16 to acquire control content corresponding to the riding situation acquired by the riding situation acquisition means 11. The control means 13 controls the one or more controlled devices in accordance with the control content acquired by the control content acquisition means 12.

The determination means 14 determines whether or not to update the control information on the basis of the control executed by the control means 13 on the one or more controlled devices and an operation result for the one or more controlled devices. In a case where the determination means 14 determines to update the control information 16, the update means 15 updates the control information 16 on the basis of an operation of the occupant on the one or more controlled devices.

In the present disclosure, the control content acquisition means 12 acquires the control content for the controlled device according to the acquired riding situation of the occupant, and the control means 13 controls the controlled device in accordance with the acquired control content. Furthermore, the determination means 14 determines whether or not to update the control information 16 according to the operation result for the controlled device after the control. The determination means 14 can determine to update the control information 16 in a case where, for example, the control means 13 controls a certain controlled device and the occupant operates another controlled device. In this manner, the present disclosure can update the control information 16 according to a reaction of the occupant to the control of the controlled device and change the control content for the controlled device in a case where the controlled device is controlled according to the riding situation.

Hereinafter, the example embodiments of the present disclosure will be described in detail with reference to the drawings. Note that, in the following description and drawings, omission and simplification are made as appropriate, for clarity of description. Furthermore, the same elements and similar elements are denoted by the same reference signs throughout the drawings, and redundant description is omitted as necessary.

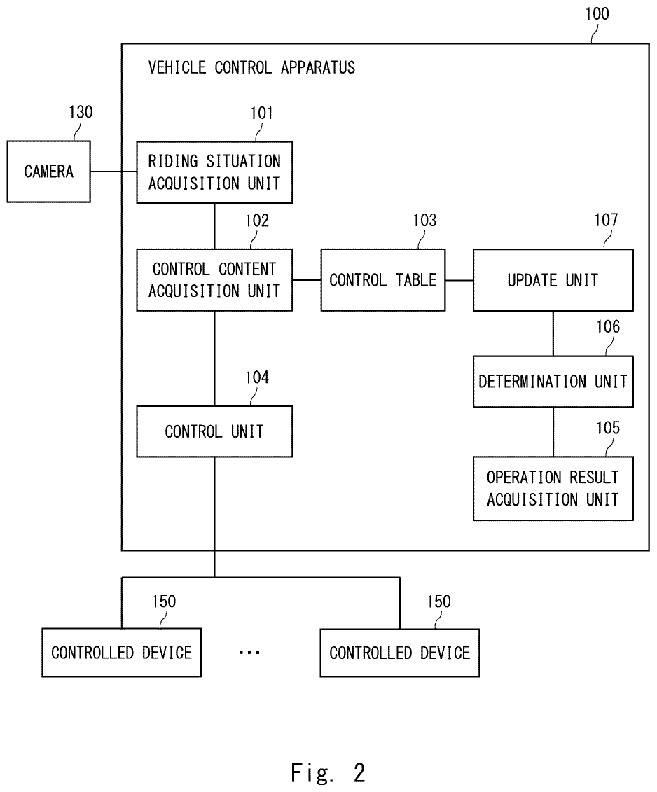

FIG. 2 illustrates a vehicle control apparatus according to a first example embodiment of the present disclosure. A vehicle control apparatus 100 includes a riding situation acquisition unit 101, a control content acquisition unit 102, a control table 103, a control unit 104, an operation result acquisition unit 105, a determination unit 106, and an update unit 107. The vehicle control apparatus 100 may be physically configured as an apparatus including, for example, one or more memories and one or more processors. At least some of functions of the units in the vehicle control apparatus 100 may be implemented in such a way that the one or more processors operate in accordance with a command read from the one or more memories. The vehicle control apparatus 100 is mounted in a vehicle, for example. The vehicle control apparatus 100 corresponds to the vehicle control apparatus 10 illustrated in FIG. 1.

The riding situation acquisition unit 101 acquires a camera image from a camera 130. The camera 130 is a camera mounted on the vehicle and images the outside of the vehicle. The camera 130 images the outside of the vehicle from, for example, the inside of the vehicle. The camera 130 images a person who intends to ride in the vehicle, that is, an occupant. Note that, although only one camera 130 is illustrated in FIG. 2, the number of cameras 130 is not limited to one. The riding situation acquisition unit 101 may acquire the camera image from each of a plurality of the cameras 130. For example, the riding situation acquisition unit 101 may acquire the camera image from each of a camera that images a front area of the vehicle, a camera that images a left side area of the vehicle, a camera that images a right side area of the vehicle, and a camera that images a rear area of the vehicle.

The riding situation acquisition unit 101 acquires a riding situation of the occupant who intends to ride in the vehicle by using the camera image. The riding situation includes, for example, information indicating who intends to ride in the vehicle with what kind of person. For example, the riding situation acquisition unit 101 identifies a person near the vehicle, that is, the occupant, from the camera image by using face authentication. More specifically, the riding situation acquisition unit 101 detects a face area of the person near the vehicle from the camera image. The riding situation acquisition unit 101 performs the face authentication by comparing a feature extracted from the detected face area with a feature of a face area of a person registered in advance as the occupant. For example, the riding situation acquisition unit 101 may identify a person approaching a driver's seat of the vehicle as a driver. The riding situation acquisition unit 101 may identify a person other than the driver as a companion. Note that the identification of the occupant is not limited to the face authentication. The riding situation acquisition unit 101 may identify the occupant by using a method other than the face authentication.

For example, the riding situation acquisition unit 101 acquires, as the riding situation, at least one of identification information regarding the occupant and attribute information regarding the occupant. In addition to the identification information regarding the occupant and the attribute information regarding the occupant, the riding situation acquisition unit 101 may acquire the number of occupants and a riding position of each occupant as the riding situations. The number of occupants can be acquired by, for example, the number of persons identified by the face authentication. Alternatively, the number of occupants can be acquired by the number of face areas detected from the camera image. Examples of an attribute of each occupant include an adult and a child. The attribute of the occupant may be estimated on the basis of, for example, an image of the detected face area. For example, the riding situation acquisition unit 101 acquires, as the riding situations, the identification information regarding the occupants, and information indicating the number of occupants and whether the occupants are only adults or the occupants include a child. The riding situation acquisition unit 101 corresponds to the riding situation acquisition means 11 illustrated in FIG. 1.

The control table 103 is a table in which the riding situation is associated with control content of one or more controlled devices 150. The controlled device 150 is a device operated by the occupant riding in the vehicle inside the vehicle. The controlled device 150 may include, for example, a device provided in the vehicle or a device operated by the occupant when the vehicle is driven. The controlled device 150 may include an in-vehicle device such as a display audio (DA) and a car navigation apparatus. Moreover, the controlled device 150 may be a user device such as a smartphone carried in the vehicle by the occupant. The control content acquisition unit 102 refers to the control table 103 to acquire control content corresponding to the riding situation acquired by the riding situation acquisition unit 101. The control content acquisition unit 102 corresponds to the control content acquisition means 12 illustrated in FIG. 1. The control table 103 corresponds to the control information 16 illustrated in FIG. 1.

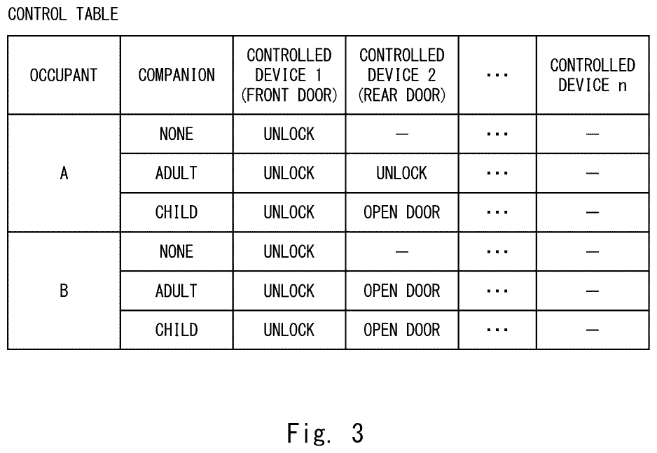

FIG. 3 illustrates an example of the control table 103. In the control table 103, for the plurality of riding situations, correspondence relationships between the riding situations and control content of the one or more controlled devices 150 are registered. In the example illustrated in FIG. 3, the riding situations include identification information regarding the occupant as the driver and information regarding a companion as the occupant other than the driver. In the information regarding the companion, it is assumed that “none” indicates that there is no companion, “adult” indicates that the companion is only an adult, and “child” indicates that the companion includes a child. In the example illustrated in FIG. 3, for occupants A and B, control content for controlled devices 1 to n is registered in the control table 103, where n is an integer of 2 or more.

In the example illustrated in FIG. 3, it is assumed that the controlled device 1 is a front door, and the controlled device 2 is a rear door. The control content for the controlled devices 1 and 2 includes “unlock” and “open door”. The control content includes not controlling the controlled device 150, in other words, not instructing anything to the controlled device 150. In an initial state, the control content of the one or more controlled devices 150 set by each occupant may be registered in the control table 103.

The control unit 104 controls the controlled device 150 according to the control content acquired by the control content acquisition unit 102. The control unit 104 can control the plurality of controlled devices 150 for each controlled device 150 in accordance with the acquired control content. In a case where the controlled device 150 is a device provided in the vehicle or a device mounted in the vehicle, the control unit 104 may transmit a control signal to the controlled device 150 through an in-vehicle network to control the controlled device 150. In a case where the controlled device 150 is a user device such as a smartphone, an application that communicates with the vehicle control apparatus 100 may be installed in the user device. The control unit 104 may transmit a control signal to the application of the user device, to control an operation of the user device.

For example, in a case where the control content acquired for the front door is “unlock”, the control unit 104 unlocks the front door. Furthermore, for example, in a case where the control content acquired for the rear door is “open door”, the control unit 104 unlocks the rear door and opens the rear door. For example, when the door is an electric sliding door, the control unit 104 transmits a control signal to a controller such as an electronic control unit (ECU) that controls the electric sliding door, and controls a motor that drives the electric sliding door. For example, when the door is a hinge door, the control unit 104 may bring the door into a half-closed state via some mechanism. The control unit 104 corresponds to the control means 13 illustrated in FIG. 1.

The operation result acquisition unit 105 acquires an operation result for the controlled device 150 after the control unit 104 controls the controlled device 150. The operation result acquisition unit 105 acquires, for example, a reaction of the occupant to the control of the controlled device 150 as the operation result. For example, in a case where the control unit 104 unlocks the door, whether the occupant has opened the door or the occupant has not opened the door is acquired as the operation result. Alternatively, in a case where the control unit 104 opens the door, whether the occupant has ridden in the vehicle from the door or the occupant has not ridden in the vehicle from the door and the door has been closed is acquired as the operation result. Which door the occupant has ridden in the vehicle can be determined on the basis of a video of a camera that images the inside of the vehicle (not illustrated in FIG. 2). In a case where a sensor for detecting passage of an object is disposed in each door, which door the occupant has ridden in can be determined according to whether or not the sensor of each door has detected passage of an object. The operation result acquisition unit 105 is also referred to as operation result acquisition means.

The determination unit 106 determines whether or not to update the control table 103 on the basis of the control executed by the control unit 104 on the controlled device 150 and the operation result acquired by the operation result acquisition unit 105. For example, the determination unit 106 determines whether or not the control content for the controlled device 150 and the operation result are different. In a case where it is determined that the control content and the operation result are different, the determination unit 106 determines to update the control table 103.

For example, the determination unit 106 determines that the control content and the operation result are different in a case where the door has been unlocked and the occupant has not ridden in the vehicle from the door. Furthermore, the determination unit 106 determines that the control content and the operation result are different in a case where the door has been opened and the occupant has not ridden in the vehicle from the door. The determination unit 106 counts the number of times the control content and the operation result are different, and in a case where the number of times the control content and the operation result are different is a predetermined number of times or more, the determination unit 106 may determine to update the control table 103. The determination unit 106 corresponds to the determination means 14 illustrated in FIG. 1.

The update unit 107 updates the control table 103 on the basis of the operation result acquired by the operation result acquisition unit 105 in a case where the determination unit 106 determines to update the control table 103. The update unit 107 changes the control content of the control table 103 such that, for the control content of the controlled devices corresponding to a certain riding situation, the control content and the operation result match. For example, in a case where the control content in the control table 103 is “unlock” and the unlocked door is not opened, the control content is changed to no control. The update unit 107 corresponds to the update means 15 illustrated in FIG. 1.

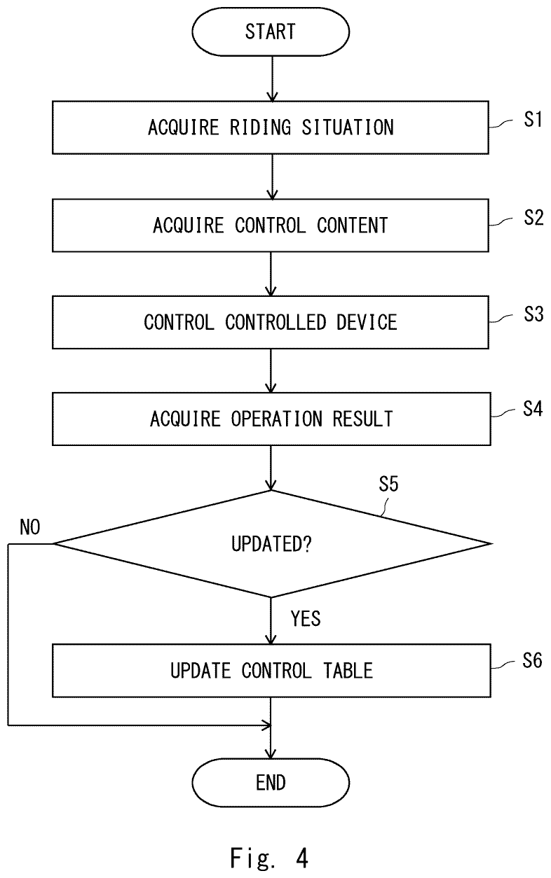

Next, an operation procedure will be described. FIG. 4 illustrates an operation procedure of the vehicle control apparatus 100. The operation procedure of the vehicle control apparatus 100 corresponds to a vehicle control method. The riding situation acquisition unit 101 acquires a riding situation of an occupant riding in a vehicle (step S1). In step S1, for example, the riding situation acquisition unit 101 performs face authentication in a camera image of the camera 130, and acquires identification information regarding the occupant, the number of occupants, and attribute information regarding the occupant.

The control content acquisition unit 102 refers to the control acquire control content corresponding to the riding situation acquired in step S1 (step S2). The control unit 104 controls the controlled device 150 in accordance with the control content acquired in step S2 (step S3). The operation result acquisition unit 105 acquires an operation of the occupant on the controlled device 150 as an operation result (step S4). In step S4, the operation result acquisition unit 105 acquires, as the operation result, a reaction of the occupant to the control of the controlled device 150 in step S3. For example, in a case where a certain door is unlocked in step S3, the operation result acquisition unit 105 acquires whether or not the occupant rides in from the door as the operation result.

The determination unit 106 determines whether or not to update the control table 103 on the basis of the operation result acquired in step S4 (step S5). In a case where it is determined in step S5 to update the control table 103, the update unit 107 updates the control table 103 (step S6). In step S6, by using the operation result acquired in step S4, the update unit 107 updates the control content corresponding to the riding situation acquired in step S1 in the control table 103.

For example, it is assumed that, in a case where a certain occupant rides in the vehicle, a door on a passenger's seat side is unlocked in step S3. Furthermore, it is assumed that the occupant opens a door on a driver's seat side and rides in the vehicle from the door on the driver's seat side. In that case, in step S6, the update unit 107 updates the control content of the control table 103 so as not to unlock the door on the passenger's seat side from the next time for the same occupant.

In the present example embodiment, the control content acquisition unit 102 acquires, from the control table 103, the control content according to the riding situation acquired by the riding situation acquisition unit 101. The control unit 104 controls the controlled device 150 according to the acquired control content. In the present example embodiment, the control content expected by the occupant is registered in the control table 103 for each riding situation, whereby the control of the controlled device 150 according to the riding situation can be executed for each occupant.

Furthermore, in the present example embodiment, the operation result acquisition unit 105 acquires the operation result for the controlled device 150 after the control unit 104 executes the control on the controlled device 150. The determination unit 106 determines whether or not to update the control table 103 according to the operation result acquired by the operation result acquisition unit 105. The determination unit 106 determines to update the control table 103 in a case where, for example, the control executed by the control unit 104 and the operation result acquired by the operation result acquisition unit 105 are different. The update unit 107 updates the control table 103 by using the operation result acquired by the operation result acquisition unit 105 in a case where it is determined to update the control table 103. In this manner, the control content in the control table 103 can be changed according to an action of the occupant after the control unit 104 controls the controlled device 150. Therefore, in the present example embodiment, even in a case where the control on the controlled device 150 at the time of the occupant riding in the vehicle changes, the control on the controlled device 150 can be executed with the changed control content.

Next, a second example embodiment of the present disclosure will be described. A configuration of a vehicle control apparatus according to the present example embodiment may be similar to the configuration of the vehicle control apparatus 100 described in the first example embodiment illustrated in FIG. 2. In the present example embodiment, a riding situation acquisition unit 101 detects an object from a camera image in addition to the operation described in the first example embodiment. In the present example embodiment, the riding situation acquisition unit 101 acquires, as a riding situation, information indicating whether or not an object such as baggage is carried. For example, the riding situation acquisition unit 101 detects an umbrella from the camera image, and acquires, as the riding situation, information indicating whether or not an occupant carries the umbrella. Alternatively or additionally, the riding situation acquisition unit 101 may detect some object from the camera image, and acquire, as the riding situation, information indicating a size of the object.

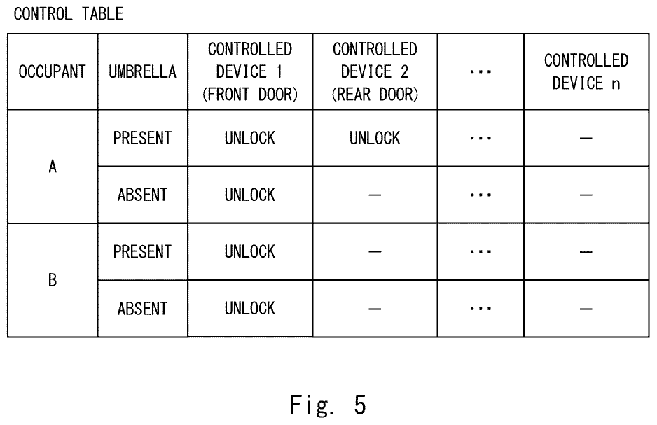

FIG. 5 illustrates an example of a control table 103 used in the present example embodiment. In this example, the riding situation includes identification information regarding an occupant who is a driver and information indicating whether or not the occupant carries an umbrella. In the information regarding the umbrella, “absent” indicates that the occupant does not carry the umbrella, and “present” indicates that the occupant carries the umbrella. In the example illustrated in FIG. 5, for occupants A and B, control content for controlled devices 1 to n in each of a case where the umbrella is carried and a case where the umbrella is not carried is registered in the control table 103. Also in the present example embodiment, similarly to the example illustrated in FIG. 3, the control table 103 may include information regarding a companion.

In the present example embodiment, a control content acquisition unit 102 acquires the control content from the control table 103 according to a combination of the occupant and the object carried by the occupant. For example, the control content acquisition unit 102 may acquire different control content between a case where the occupant A carries the umbrella and a case where the occupant A does not carry the umbrella. Alternatively, for example, the control content acquisition unit 102 may acquire different control contents between a case where the occupant A carries a large object and a case where the occupant A carries a small object. A control unit 104 controls the controlled device 150 in accordance with the control content acquired by the control content acquisition unit 102.

In the present example embodiment, the riding situation acquisition unit 101 performs the object detection, and detects what kind of object the occupant carries. The control content acquisition unit 102 acquires the control content of the controlled device 150 according to the detected object from the control table 103. In the present example embodiment, the different control content is registered in the control table 103 according to the carried object, so that the control executed on the controlled device 150 can be changed according to what kind of baggage the occupant carries. Other effects are similar to the effects described in the first example embodiment.

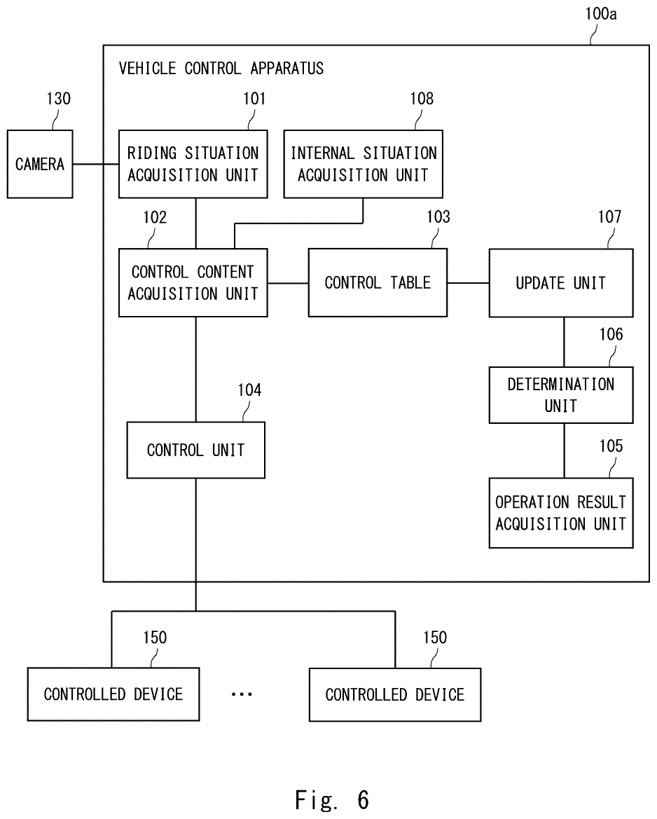

Next, a third example embodiment of the present disclosure will be described. FIG. 6 illustrates a vehicle control apparatus according to the third example embodiment of the present disclosure. In the present example embodiment, a vehicle control apparatus 100a includes an internal situation acquisition unit 108 in addition to the components of the vehicle control apparatus 100 according to the first example embodiment illustrated in FIG. 2. The internal situation acquisition unit 108 acquires an internal situation of a vehicle. An operation of the vehicle control apparatus 100a according to the present example embodiment is different from the operation of the vehicle control apparatus 100 described in the first or second example embodiment in that the internal situation of the vehicle is used to control a controlled device 150.

The internal situation acquisition unit 108 acquires, for example, use situations of a seat and a luggage room as the internal situations of the vehicle. The internal situation acquisition unit 108 acquires, for example, whether a person is sitting on the seat or baggage is in the luggage room as the internal situation of the vehicle. For example, the internal situation acquisition unit 108 may acquire an in-vehicle camera image from a camera (not illustrated) that images an area inside the vehicle, and detect the person sitting on the seat and the baggage placed in the luggage room from the in-vehicle camera image. The internal situation acquisition unit 108 may detect the occupant or the baggage using a sensor such as a pressure sensor provided in the seat or the luggage room. The internal situation acquisition unit 108 is also referred to as internal situation acquisition means.

In the present example embodiment, in a control table 103, control content is registered for a combination of a riding situation of the occupant and the internal situation in the vehicle. A control content acquisition unit 102 acquires control content of the controlled device 150 from the control table 103 according to the riding situation acquired by a riding situation acquisition unit 101 and the internal situation acquired by the internal situation acquisition unit 108. A control unit 104 controls the controlled device 150 in accordance with the control content acquired by the control content acquisition unit 102.

In the present example embodiment, the internal situation of the vehicle is acquired in addition to the riding situation of the occupant. In the present example embodiment, the different control content is registered in the control table 103 according to the combination of the riding situation of the occupant and the internal situation of the vehicle, so that the control executed on the controlled device 150 can be changed according to the riding situation of the occupant and the internal situation of the vehicle. Other effects are similar to the effects described in the first or second example embodiment.

Note that, in the above example embodiment, the control content acquisition unit 102 may acquire the control content for the controlled device 150 by using other information in addition to the riding situation of the occupant. For example, the control content acquisition unit 102 may acquire information from an external server and acquire the control content for the controlled device 150 using the information acquired from the external server. For example, the control content acquisition unit 102 may acquire information regarding weather from the external server, and acquire the control content for the controlled device 150 on the basis of the riding situation of the occupant and the acquired information regarding the weather. In that case, the control content for the controlled device 150 may be registered in the control table 103 for each combination of the riding situation of the occupant and the information regarding the weather.

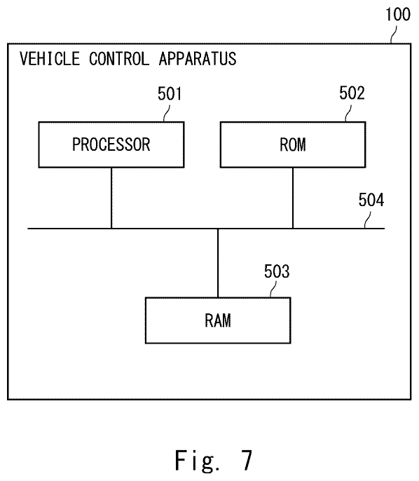

Next, a hardware configuration of the vehicle control apparatus 100 will be described. FIG. 7 illustrates the hardware configuration of the vehicle control apparatus 100. The vehicle control apparatus 100 includes a processor (central processing unit (CPU)) 501, a read only memory (ROM) 502, and a random access memory (RAM) 503. In the vehicle control apparatus 100, the processor 501, the ROM 502, and the RAM 503 are interconnected via a bus 504. The vehicle control apparatus 100 may include another circuit such as a peripheral circuit, a communication circuit, and an interface circuit, although illustration thereof is omitted.

The ROM 502 is a nonvolatile storage device. For example, a semiconductor storage device such as a flash memory having a relatively small capacity is used for the ROM 502. The ROM 502 stores a program executed by the processor 501.

The program described above includes a group of commands (or software codes) for causing a computer to perform one or more functions described in the example embodiments in a case where the program is read by the computer. The program may be stored in a non-transitory computer-readable medium or a tangible storage medium. By way of example, and not limitation, computer-readable media or tangible storage media include a RAM, a ROM, a flash memory, a solid-state drive (SSD) or other memory technologies, a compact disc (CD), a digital versatile disc (DVD), a Blu-ray (registered trademark) disc or other optical disc storages, a magnetic cassette, a magnetic tape, a magnetic disk storage or other magnetic storage devices. The program may be transmitted on a transitory computer-readable medium or a communication medium. By way of example, and not limitation, transitory computer-readable or communication media include electrical, optical, acoustic, or other forms of propagated signals.

The RAM 503 is a volatile storage device. As the RAM 503, various types of semiconductor memory devices such as a dynamic random access memory (DRAM) or a static random access memory (SRAM) are used. The RAM 503 may be used as an internal buffer for transitorily storing data and the like.

The processor 501 develops the program stored in the ROM 502 on the RAM 503, and executes the program. The functions of the units in the vehicle control apparatus 100 may be implemented by the CPU 501 executing the program.

Note that the vehicle control apparatus 100 is not necessarily a single apparatus. The vehicle control apparatus 100 may be configured using a plurality of physically separated apparatuses. Furthermore, the vehicle control apparatus 100 only needs to be able to control the controlled device 150 in the vehicle, and does not necessarily have all the functions mounted on the vehicle. For example, in the vehicle control apparatus 100, the determination unit 106 and the update unit 107 may be disposed outside the vehicle. In that case, the determination unit 106 may receive the operation result from the operation result acquisition unit 105 via a wireless communication network. Furthermore, the update unit 107 may access the control table 103 via the wireless communication network and update the control table 103.

Although the example embodiments of the present disclosure have been described above in detail, the present disclosure is not limited to the above example embodiments, and the present disclosure also includes changes or modifications made to the above example embodiments without departing from the scope of the present disclosure.

### REFERENCE SIGNS LIST

10 VEHICLE CONTROL APPARATUS
11 RIDING SITUATION ACQUISITION MEANS
12 CONTROL CONTENT ACQUISITION MEANS
13 CONTROL MEANS
14 DETERMINATION MEANS
15 UPDATE MEANS
16 CONTROL INFORMATION
100 VEHICLE CONTROL APPARATUS
101 RIDING SITUATION ACQUISITION UNIT
102 CONTROL CONTENT ACQUISITION UNIT
103 CONTROL TABLE
104 CONTROL UNIT
105 OPERATION RESULT ACQUISITION UNIT
106 DETERMINATION UNIT
107 UPDATE UNIT
130 CAMERA
150 CONTROLLED DEVICE
501 PROCESSOR
502 ROM
503 RAM
504 BUS

What is claimed is:

1. A vehicle control apparatus comprising:
at least one memory storing instructions; and
at least one processor configured to execute the instructions to:
acquire a riding situation of an occupant riding in a vehicle;
acquire control content corresponding to the acquired riding situation by using control information in which riding situations and control content of one or more controlled devices are associated with each other;
control the one or more controlled devices in accordance with the acquired control content;
determine whether or not to update the control information on the basis of the control executed on the one or more controlled devices and an operation result for the one or more controlled devices; and
update the control information on the basis of an operation of the occupant on the one or more controlled devices in a case where it is determined to update the control information.

2. The vehicle control apparatus according to claim 1, wherein the at least one processor is configured to execute the instructions to:
determine whether or not the control executed on the one or more controlled devices and the operation result for the one or more controlled devices are different; and
determine to update the control information in a case where it is determined that the control and the operation result are different.

3. The vehicle control apparatus according to claim 1, wherein the at least one processor is configured to execute the instructions to acquire the riding situation of the occupant on the basis of a camera image of a camera configured to image a periphery of the vehicle.

4. The vehicle control apparatus according to claim 3, wherein the at least one processor is configured to execute the instructions to perform face authentication on the camera image, and acquires at least one of identification information regarding the occupant and attribute information regarding the occupant as the riding situation of the occupant.

5. The vehicle control apparatus according to claim 4, wherein the attribute information regarding the occupant includes an adult and a child.

6. The vehicle control apparatus according to claim 3, wherein the at least one processor is configured to execute the instructions to perform object detection on the camera image, and acquires an object carried by the occupant as the riding situation of the occupant.

7. The vehicle control apparatus according to claim 1, wherein the at least one processor is configured to execute the instructions to acquire an operation result of the occupant for the one or more controlled devices.

8. The vehicle control apparatus according to claim 1, wherein:
the at least one processor is configured to execute the instructions to acquire an internal situation of the vehicle,
in the control information, the riding situation and the internal situation are associated with the control content of the one or more controlled devices, and
the at least one processor is configured to execute the instructions to acquire the control content corresponding to the acquired riding situation and the acquired internal situation.

9. A vehicle control method comprising:
acquiring a riding situation of an occupant riding in a vehicle;
acquiring control content corresponding to the acquired riding situation by using control information in which riding situations and control content of one or more controlled devices are associated with each other;
controlling the one or more controlled devices in accordance with the acquired control content;
determining whether or not to update the control information on the basis of the control on the one or more controlled devices and an operation result for the one or more controlled devices; and
updating the control information on the basis of an operation of the occupant on the one or more controlled devices in a case where it is determined to update the control information.

10. A non-transitory computer-readable medium storing a program for causing a processor to execute processing comprising:
acquiring a riding situation of an occupant riding in a vehicle;
acquiring control content corresponding to the acquired riding situation by using control information in which riding situations and control content of one or more controlled devices are associated with each other;
controlling the one or more controlled devices in accordance with the acquired control content;
determining whether or not to update the control information on the basis of the control on the one or more controlled devices and an operation result for the one or more controlled devices; and
updating the control information on the basis of an operation of the occupant on the one or more controlled devices in a case where it is determined to update the control information.
